(19) United States
(12) Patent Application Publication
(10) Pub. No.: US 2023/0334372 A1
(43) Pub. Date: Oct. 19, 2023

(54) SYSTEMS AND METHODS FOR OPTIMIZING A MACHINE LEARNING MODEL BASED ON A PARITY METRIC

(71) Applicant: ARIZE AI, INC., Mill Valley, CA (US)

(72) Inventors: Jason LOPATECKI, Mill Valley, CA (US); Reah MIYARA, Mill Valley, CA (US); Tsion BEHAILU, Mill Valley, CA (US); Aparna DHINAKARAN, Dublin, CA (US)

(73) Assignee: ARIZE AI, INC., Mill Valley, CA (US)

(21) Appl. No.: 18/300,093

(22) Filed: Apr. 13, 2023

Related U.S. Application Data
(60) Provisional application No. 63/363,103, filed on Apr. 15, 2022.

(51) Int. Cl. G06N 20/00

(52) U.S. Cl. CPC G06N 20/00

(57) ABSTRACT

Techniques for optimizing a machine learning model. The techniques may include obtaining multiple predictions from a machine learning model, the predictions being based on at least one input feature vector, each input feature vector having one or more vector values; creating at least one slice of the predictions based on at least one vector value; determining a sensitive bias metric for the slice based on a sensitive group; determining a base metric for the slice based on a base group; determining a parity metric for the slice based on a ratio of the sensitive bias metric and the base metric; and optimizing the machine learning model based on the parity metric.

### RELATED APPLICATIONS

This application claims priority from U.S. Provisional Application No. 63/363,103 filed Apr. 15, 2022. This application is also related to U.S. Pat. No. 11,315,043, U.S. patent application Ser. Nos. 17/548,070, 17/703,205, and 17/658,737. All of the foregoing are incorporated by reference in their entireties.

### BACKGROUND

Machine learning models are used for predictions e.g., taking inputs from data and making predictions. Known work on models has been focused on the training and building areas of model development. But models are trained on biased data sets and cause them to make biased predictions. Examples of biased datasets include data that is highly correlated with race/gender (or data that is historically biased based on previous decisions) causing the model to exhibit biased decisions. These model decisions can affect the outcome, for example, of people applying for credit or loans based on race even though race itself is not a feature in the model.

Known techniques to optimize a machine learning model utilize overall aggregate performance and/or average performance metrics. With such techniques, however, it is difficult to identify biases that are mainly responsible for affecting the model's overall performance. There is a desire and need to overcome these challenges.

### SUMMARY

A system for optimizing a machine learning model is disclosed. The system may comprise: a machine learning model that generates predictions based on at least one input feature vector, each input feature vector having one or more vector values; and an optimization module with a processor and an associated memory, the optimization module being configured to: create at least one slice of the predictions based on at least one vector value, determine a sensitive bias metric for the slice based on a sensitive group, determine a base metric for the slice based on a base group, determine a parity metric for the slice based on a ratio of the sensitive bias metric and the base metric, and optimize the machine learning model based on the parity bias metric.

A computer-implemented method for optimizing a machine learning model is disclosed. The method may comprise the following steps: obtaining multiple predictions from a machine learning model, the predictions being based on at least one input feature vector, each input feature vector having one or more vector values; creating at least one slice of the predictions based on at least one vector value; determining a sensitive bias metric for the slice based on a sensitive group; determining a base metric for the slice based on a base group; determining a parity metric for the slice based on a ratio of the sensitive bias metric and the base metric; and optimizing the machine learning model based on the parity metric.

In example embodiments, the parity metric can be Recall parity, False Positive Rate (FPR) parity, Disparate Impact (DI), False Negative Rate (FNR) parity, False Positive/Group Size (FP/GS) parity, False Negative/Group Size (FN/GS) parity, Accuracy parity, Proportional parity, False Omission Rate (FOR) parity, or False Discovery Rate (FDR) parity.

### BRIEF DESCRIPTION OF DRAWINGS

Other objects and advantages of the present disclosure will become apparent to those skilled in the art upon reading the following detailed description of exemplary embodiments, in conjunction with the accompanying drawings, in which like reference numerals have been used to designate like elements, and in which:

FIG. 1 shows a system for optimizing a machine learning model according to an exemplary embodiment of the present disclosure;

FIG. 2 shows a diagram comparing predictions with latent truth data according to an exemplary embodiment of the present disclosure;

FIGS. 3A and 3B show diagrams of slices based on different vector values according to an exemplary embodiment of the present disclosure;

FIG. 4 shows a diagram with certain input feature vectors according to an exemplary embodiment of the present disclosure;

FIG. 5 illustrates predictions of a machine learning model according to an exemplary embodiment of the present disclosure;

FIG. 6 illustrates a calculation of a bias metric according to an exemplary embodiment of the present disclosure;

FIG. 7 illustrates a calculation of a bias metric according to an exemplary embodiment of the present disclosure;

FIG. 8 illustrates a calculation of a bias metric according to an exemplary embodiment of the present disclosure;

FIG. 9 illustrates a calculation of a bias metric according to an exemplary embodiment of the present disclosure;

FIG. 10 illustrates a calculation of a bias metric according to an exemplary embodiment of the present disclosure;

FIG. 11 illustrates a calculation of a bias metric according to an exemplary embodiment of the present disclosure;

FIG. 12 illustrates a calculation of a bias metric according to an exemplary embodiment of the present disclosure;

FIG. 13 illustrates a calculation of a bias metric according to an exemplary embodiment of the present disclosure;

FIG. 14 illustrates a calculation of a bias metric according to an exemplary embodiment of the present disclosure;

FIG. 15 illustrates a calculation of a bias metric according to an exemplary embodiment of the present disclosure;

FIG. 16 shows a flowchart for a method of optimizing the machine learning model according to an exemplary embodiment of the present disclosure; and

FIG. 17 illustrates a machine configured to perform computing operations according to an embodiment of the present disclosure.

### DESCRIPTION

The present disclosure provides systems and methods to overcome the aforementioned and other challenges. The disclosed systems and methods highlight specific data used to build a model that may cause the overall bias issues discussed herein, which is disregarded by known model optimization approaches that are global in nature.

The disclosed techniques can be deployed to analyze a machine learning model where certain predictions or groups of predictions generated by the model are biased. The bias can arise due to features that are not part of the model. For example, a racial bias may be found in credit or loan applications that require a zip code because, even though race itself is not a feature in the model, the zip code can be associated with a particular race. The techniques described herein can identify and analyze such predictions to optimize the machine learning model.

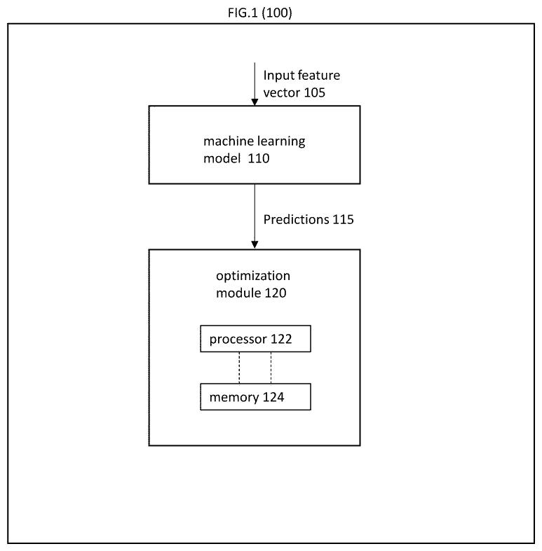

FIG. 1 shows an example system 100 for optimizing a machine learning model. The system 100 may include a machine learning model 110 that can generate multiple predictions 115 based on at least one input feature vector 105. The input feature vector 105 can have one or more vector values. The machine learning model 110 can be trained using a training dataset and one or more algorithms.

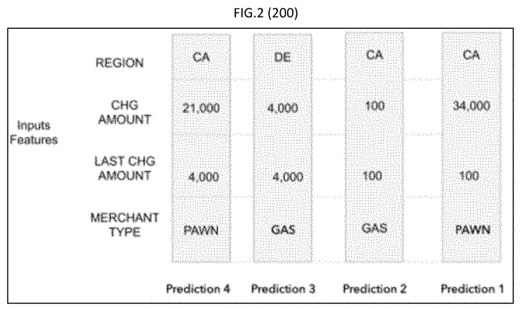

Input feature vector 105, as used herein, can be an individual measurable property or characteristic of a phenomenon being observed. For example, FIG. 2 shows an example diagram 200 with example input feature vectors 105 shown as ‘REGION’, ‘CHG AMOUNT’, ‘LAST CHG AMOUNT’ and ‘MERCHANT TYPE’, each with multiple vector values. ‘REGION’ can have values of ‘CA’ and ‘DE’. ‘CHG AMOUNT’ can have values of ‘21,000’, ‘4,000’, ‘100’ and ‘34,000’. ‘LAST CHG AMOUNT’ can have values of ‘4,000’, ‘4,000’, ‘100’ and ‘100’. ‘MERCHANT TYPE’ can have values of ‘PAWN’ and ‘GAS’.

Diagram 200 further shows multiple predictions 115 (Predictions 1, 2, 3 and 4), such that each prediction can have values based on each input feature vector 105. For example, Prediction 1 has values ‘CA’, ‘34,000’, ‘100’ and ‘PAWN’. Prediction 2 has values ‘CA’, ‘100’, ‘100’ and ‘GAS’. Prediction 3 has values ‘DE’, ‘4,000’, ‘4,000’ and ‘GAS’. Prediction 4 has values ‘CA’, ‘21,000’, ‘4,000’ and ‘PAWN’.

Referring again to FIG. 1, the system 100 can include an optimization module 120 with a processor 122 (e.g., a central processing unit (CPU), a graphics processing unit (GPU), etc.) and an associated memory 124. The optimization module 120 can be configured to create at least one slice (i.e., grouping) of the predictions 115 based on at least one vector value 105.

In an example embodiment, a user input (e.g., touchscreen, mouse-click, etc.) can be used to generate a slice by grouping the predictions 115 on a user interface. A machine learning algorithm can be applied to the multiple predictions 115 to create the at least one slice of the predictions. As such, unsupervised learning algorithms (e.g., k-means) that do not require pre-existing labels can be used. Alternately supervised learning algorithms can also be used.

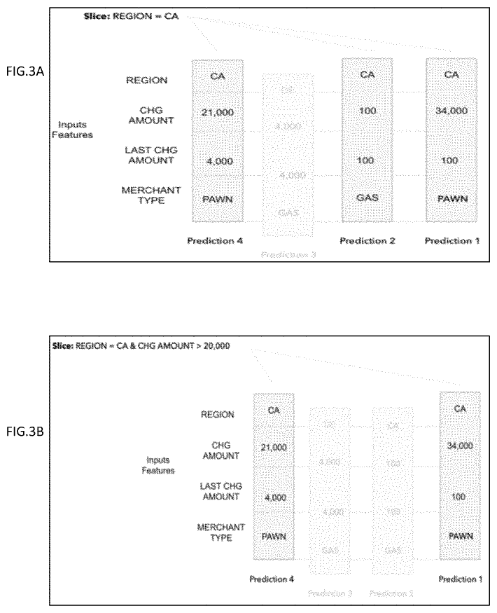

FIG. 3A shows an example slice based on REGION=CA created using any of the aforementioned techniques. Such a slice includes Predictions 4, 2 and 1. FIG. 3B shows another example slice based on REGION=CA and CHG AMOUNT>20,000 created using any of the aforementioned techniques. Such a slice includes Predictions 4 and 1.

The optimization module 120 can be configured to determine at least one optimization metric of the slice that is based on at least a number of total predictions for the vector value. The determination of various optimization metrics are described as follows.

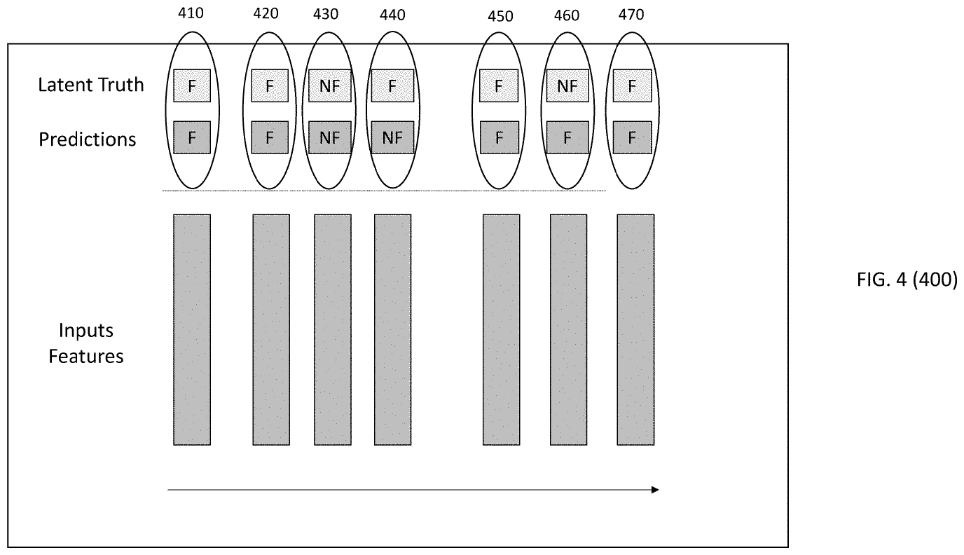

FIG. 4 shows an example diagram 400 to visualize a generation of various optimization metrics. Diagram 400 shows seven predictions (each input feature corresponding to a slice of prediction) compared with the latent truth data (e.g., ground truth) to determine which of the multiple predictions are correct or incorrect. Of these, for predictions 410, 420, 430, 450 and 470, the latent truth data matches the predictions. Therefore, the overall accuracy is (5/7)*100 =71.42%.

If a prediction of a slice is true (also called not false (NF)) and a latent truth (aka actual) of the slice is also true, their comparison is considered a True Positive (TP). 430 is an example of a TP. If a prediction is true but a latent truth is false, their comparison is considered a False Positive (FP). 440 is an example of a FP. If the prediction is false and a latent truth is also false, their comparison is considered a True Negative (TN). 410, 420, 450 and 470 are examples of a TN. If the prediction is false but a latent truth is true, their comparison is considered a False Negative (FN). 460 is an example of a FN. Therefore, the number of TPs=1, the number of FPs =1, the number of TNs=4 and the number of FNs=1.

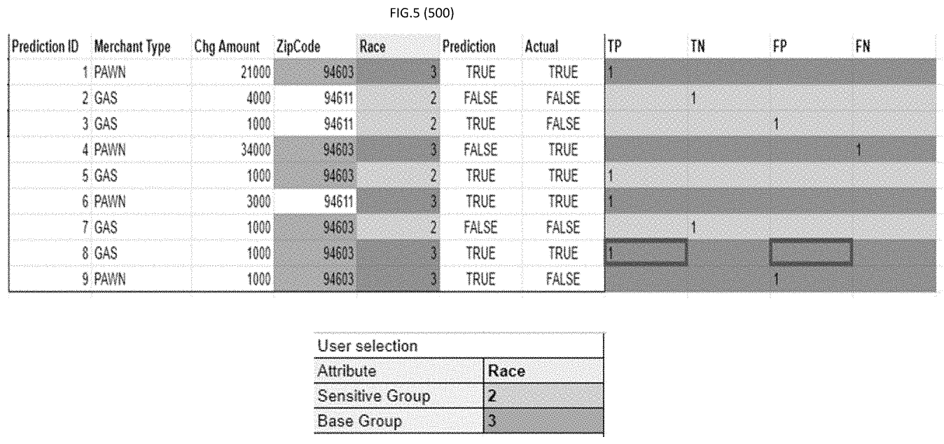

FIG. 5 shows another example diagram 500 visualizing a generation of various optimization metrics. Diagram 500 illustrates nine predictions (Prediction ID 1-9) compared with the latent truth data. Of these, Predictions 1, 5, and 8 are TPs (prediction and latent truth (actual) both are true (or not false)), Predictions 2 and 7 are TNs (prediction and latent truth both are false), Predictions 3 and 9 are FPs (prediction is true (or not false) and actual is false), Prediction 4 and 6 are FNs (prediction is false but actual is true (or not false)).

In an example embodiment, the optimization module 120 can be configured to determine an optimization metric called Recall, which can be a ratio of a number of TPs and a sum of a number of TPs and FNs. That is, Recall=TP/(TP+FN). In the example of diagram 400, Recall=(1)/(1+1)=1/2.

In the example of FIG. 5, predictions associated with the sensitive group (i.e., Race feature=2) are 2, 3, 5, and 7. Of these, TP is Prediction 5 (i.e., number of T_{‘Race=2’}=1) and there are no FNs (i.e., number of FN_{‘Race=2’}=0). Therefore, Recall_{‘Race=2’}=number of TP_{‘Race=2’}/(number of TP_{‘Race=2’}+number of FN_{‘Race=2’})=1/(1+0)=1. Here, the sensitive group is based on Race, but a person of skill in the art would understand that it can be based on other attributes such as gender, sexual orientation, class, national origin, to name a few, or any combination thereof. Predictions associated with the base group (i.e., Race feature=3) are 1, 4, 6, 8 and 9. Of these, TPs are Predictions 1, 6, and 8 (i.e. number of TP_{‘Race=3’}=3) and FNs is Prediction 4 (i.e. number of FN_{‘Race=3’}=1). Therefore, Recall_{‘race=3’}=number of TP_{‘Race=3’}/(number of TP_{‘Race=2’}+number of FN_{‘Race=2’})=3/(3+1) =¾.

In an example embodiment, the optimization module 120 can be configured to determine an optimization metric called Recall Parity (aka Equal Odds Parity), which can be a ratio of Recall of a sensitive group and a Recall of a base group. That is, Recall Parity=Recallₛₑₙₛᵢₜᵢᵥₑ/Recall_{base}. In the above example of FIG. 5, Recall Parity (for the entire set of predictions)=Recall_{‘Race=2’/}Recall_{‘Race=3’}=1/(¾)= 4/3=1.33.

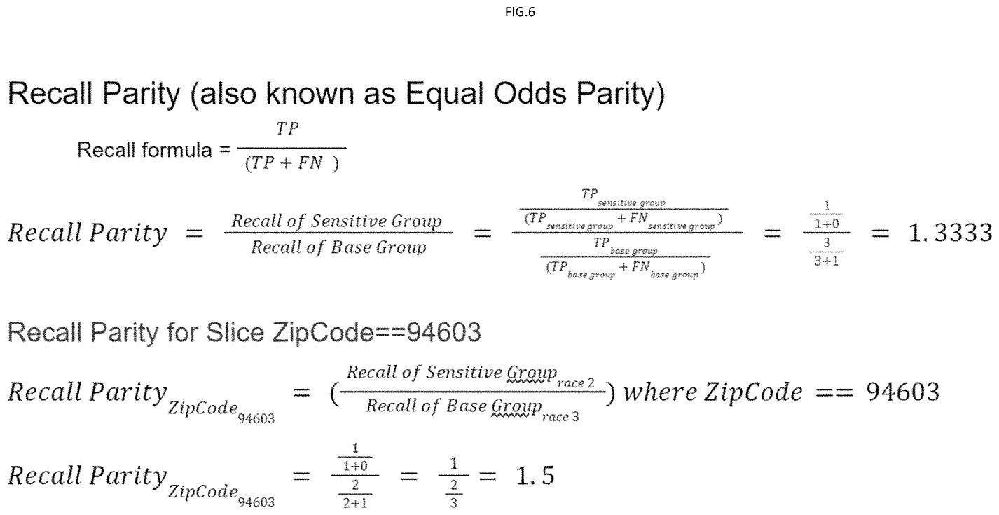

Like the calculation for the entirety of predictions, Recall Parity can be calculated for one or more slices of the predictions (e.g., slice where zip code=94603). Zipcode=94603 for Predictions 1, 4, 5, 7, 8, and 9. Of these, predictions associated with the sensitive group (i.e., Race=2) are 5 and 7. Of these, TP is Prediction 5 (i.e. number of TP_{‘Race=2’&& ‘zipcode=94603’}=1) and there are no FNs (i.e. number of FN_{‘Race=2’&& ‘zipcode=94603’}=0). Therefore, Recall_{‘Race=2’&& ‘zipcode=94603’}=number of TP_{‘Race=2’&& ‘zipcode=94603’}/(number of TP_{‘Race=2’&& ‘zipcode=94603’}+number of FN_{‘Race=2’&& ‘zipcode=94603’})=1/(1+0). Therefore, Recall_{‘Race=2’&& ‘zipcode=94603’}=1. Similarly, for Zipcode=94603, predictions associated with the base group (i.e., Race=3) are 1, 4, 8 and 9. Of these, TPs are Predictions 1 and 8 (i.e. number of TP_{‘Race=3’&& ‘zipcode=94603’}=2) and Prediction 4 is a FN (i.e. number of FN_{‘Race=3’&& ‘zipcode=94603’}=1). Therefore, ReCall_{‘Race=3’&& ‘zipcode=94603’}=number of TP_{‘Race=3’&& ‘zipcode=94603’}/(number of TP_{‘Race=3’&& ‘zipcode=94603’}+number of FN_{‘Race=3’&& ‘zipcode=94603’})=2/(2+1)=⅔. Therefore, Recall Parity (for slice where zip code=94603)=Recall_{‘Race=2’&& ‘zipcode=94603’}/Recall _{‘Race=3’&& ‘zipcode=94603’}=1/(⅔)=1.5. These calculations are illustrated in FIG. 6.

While the previous example is directed at the Recall Parity (aka Equal Odds Parity) optimization metric, a person of ordinary skill in the art would appreciate that the optimization module 120 can be configured to determine various other optimization metrics. For example, optimization metrics such False Positive Rate (FPR) Parity, Disparate Impact (DI), False Negative Rate (FNR) Parity, False Negative Rate (FNR) Parity, False Positive/Group Size (FP/GS) Parity, False Positive/Group Size (FP/GS) Parity, False Negative/Group Size (FN/GS) Parity, False Negative/Group Size (FN/GS) Parity, Accuracy (Acc) Parity, Proportional (Prop) Parity, False Omission Rate (FOR) Parity, False Discovery Rate (FDR) Parity, or any combination thereof can be analyzed.

Continuing with the previous example of determining metrics based on the slice of the predictions where zip code=94603 in FIG. 5, number of TP_{‘Race=3’&& ‘zipcode=94603’}=2; number of TP_{‘Race=2’&& ‘zipcode=94603’}=1; number of FP_{‘Race=3’&& ‘zipcode=94603’}=1; number of FP_{‘Race=2’&& ‘zipcode=94603’}=0; number of TN_{‘Race=3’&& ‘zipcode=94603’}=0; number of TN_{‘Race=2’&& ‘zipcode=94603’}=1; number of FN_{‘Race=3’&& ‘zipcode=94603’}=1; number of FN_{‘Race=3’&& ‘zipcode=94603’}=0.

In an example embodiment, the optimization module 120 can be configured to determine an optimization metric called False Positive Rate (FPR), which can be a ratio of a number of FPs and a sum of a number of TNs and FPs. That is, FPR=FP/(TN +FP). The optimization module 120 can be further configured to determine an optimization metric called False Positive Rate (FPR) Parity, which can be a ratio of FPR of a sensitive group and FPR of a base group. That is, FPR Parity=FPRₛₑₙₛᵢₜᵢᵥₑ/FPR_{base}.

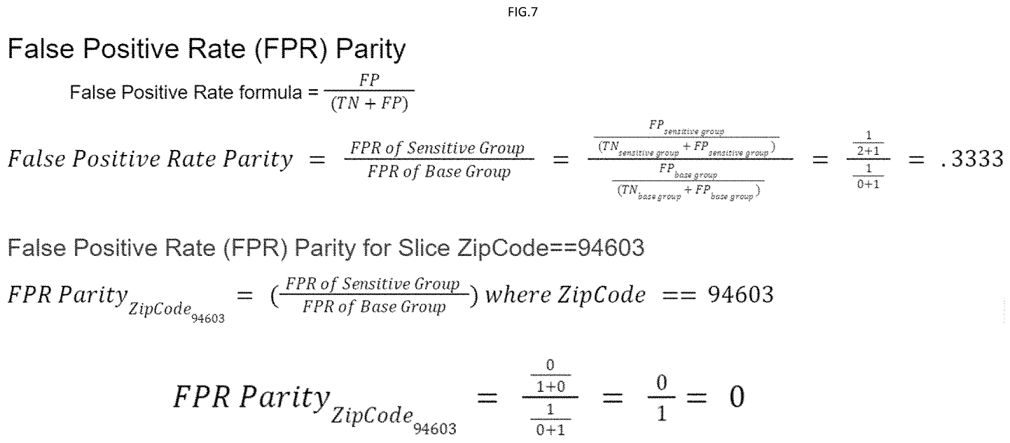

Like the calculation for the entirety of predictions, FPR Parity can be calculated for one or more slices of the predictions (e.g., slice where zip code=94603). FPR_{‘Race=2’&& ‘zipcode=94603’}=number of FP_{‘Race=2’&& ‘zipcode=94603’}/(number of TN_{‘Race=2’&& ‘zipcode=94603’}+number of FP_{‘Race=2’&& ‘zipcode=94603’})=0/(1+0)=0. FPR_{‘Race=3’&& ‘zipcode=94603’}=number of FP_{‘Race=3’&& ‘zipcode=94603’}/(number of TN_{‘Race=3’&& ‘zipcode=94603’}+number of FP_{‘Race=3’&& ‘zipcode=94603’})=1/(0+1)=1. Therefore, FPR Parity (for slice where zip code=94603)=FPR _{‘Race=2’&& ‘zipcode=94603’}/FPR _{‘Race=3’&& ‘zipcode=94603’}=(0)/(1)=0. These calculations are illustrated in FIG. 7.

In an example embodiment, the optimization module 120 can be configured to determine an optimization metric called Disparate Impact (DI), which is a ratio of (a ratio of a number of positive outcomes in the sensitive group and the total number of outcomes in the sensitive group) and (a ratio of a number of positive outcomes in the base group and the total number of outcomes in the base group). Number of positive outcomes is a sum of the True Positives and False Positives.

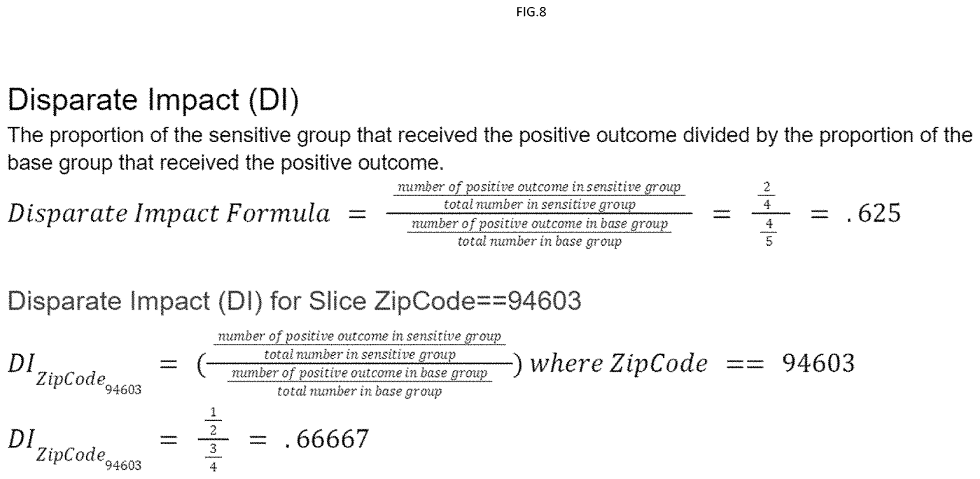

As with other optimization metrics, DI can be calculated for one or more slices of the predictions (e.g., slice where zip code=94603). DI_{‘zipcode=94603’}=((number of positive outcomes in the sensitive group)/(total number of outcomes in the sensitive group))/((number of positive outcomes in the base group)/(the total number of outcomes in the base group)) where zipcode=94603. Number of positive outcomes in the sensitive group where zipcode=94603=TP_{‘Race=2’&& ‘zipcode=94603’}+FP_{‘Race=2’&& ‘zipcode=94603’}=1+0=1. The total number of outcomes in the sensitive group where zipcode=94603 is 2. The number of positive outcomes in the base group where zipcode=94603=TP_{‘Race=3’&& ‘zipcode=94603’}+FR_{‘Race=3’&& ‘zipcode=94603’}=2+1=3. The total number of outcomes in the base group where zipcode=94603 is 4. Therefore, DI_{‘zipcode=94603’}=(½)/(¾)=⅔=0.6667. These calculations are illustrated in FIG. 8.

In an example embodiment, the optimization module 120 can be configured to determine an optimization metric called False Negative Rate (FNR), which is a ratio of a number of FNs and a sum of a number of TPs and FNs. That is, FNR=FN/(TP+FN). The optimization module 120 can be further configured to determine an optimization metric called False Negative Rate (FNR) Parity, which can be a ratio of FNR of a sensitive group and FNR of a base group. That is, FNR Parity=FNRₛₑₙₛᵢₜᵢᵥₑ/FNR_{base}.

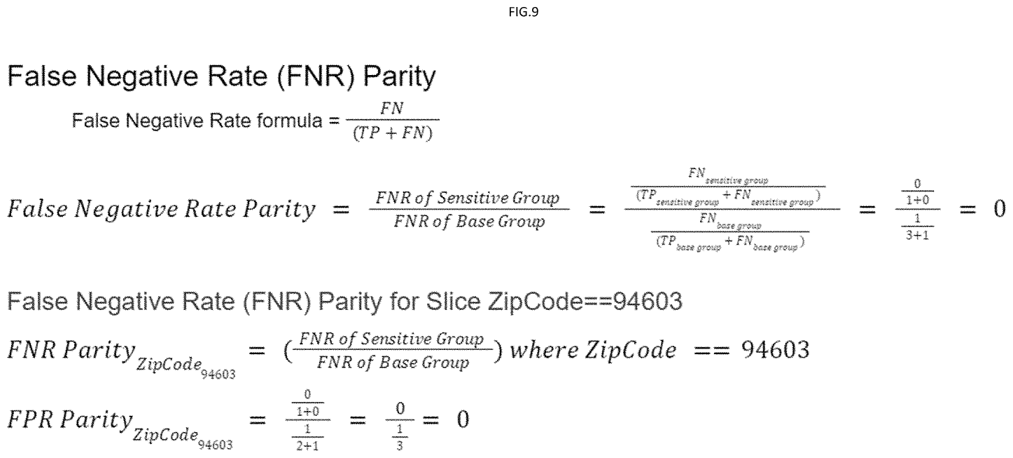

Like the calculation for the entirety of predictions, FNR Parity can be calculated for one or more slices of the predictions (e.g., slice where zip code=94603). FNR_{‘Race=2’&& ‘zipcode=94603’}=number of FN_{‘Race=2’&& ‘zipcode=94603’}/(number of TP_{‘Race=2’&& ‘zipcode=94603’}+number of FN_{‘Race=2’&& ‘zipcode=94603’})=0/(1+0)=0. FNR_{‘Race=3’&& ‘zipcode=94603’}=number of FN_{‘Race=3’&& ‘zipcode=94603’}/(number of TP_{‘Race=2’&& ‘zipcode=94603’}+number of FN_{‘Race=2’&& ‘zipcode=94603’})=1/(1+0)=1. Therefore, FNR Parity (for slice where zip code=94603)=FNR _{‘Race=2’&& ‘zipcode=94603’}/FNR _{‘Race=3’&& ‘zipcode=94603’}=(0)/(1)=0. These calculations are illustrated in FIG. 9.

In an example embodiment, the optimization module 120 can be configured to determine an optimization metric called False Positive/Group Size (FP/GS), which is a ratio of a total number of FPs and the total group size. The optimization module 120 can be further configured to determine an optimization metric called FP/GS Parity, which can be a ratio of FP/GS of a sensitive group and FP/GS of a base group. That is, FP/GS Parity=FP/GSₛₑₙₛᵢₜᵢᵥₑ/FP/GS_{base}.

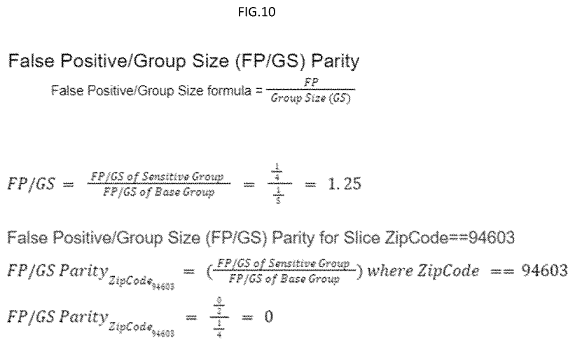

As with other optimization metrics, FP/GS can be calculated for one or more slices of the predictions (e.g., slice where zip code=94603). FP/GS _{‘zipcode=94603’}=number of FPs/group size, where zipcode=94603. Number of FPs in the sensitive group where zipcode is 94603=FP_{‘Race=2’&& ‘zipcode=94603’}=0. Total number of outcomes in the sensitive group where zipcode=94603 is 2. FP/GS_{‘Race=2’&& ‘zipcode=94603’}=0/2=0. Number of FPs in the base group where zipcode is 94603=FP_{‘Race=3’&& ‘zipcode=94603’}=1. The total number of outcomes in the base group where zipcode=94603 is 4. FP/GS_{‘Race=3’&& ‘zipcode=94603’}=¼=0.25. Therefore, FP/GS Parity _{‘zipcode=94603’}=(0)/(0.25)=0. These calculations are illustrated in FIG. 10.

In an example embodiment, the optimization module 120 can be configured to determine an optimization metric called False Negative/Group Size (FN/GS), which is a ratio of a total number of FNs and the total group size. The optimization module 120 can be further configured to determine an optimization metric called FN/GS Parity, which can be a ratio of FN/GS of a sensitive group and FN/GS of a base group. That is, FN/GS Parity=FN/GSₛₑₙₛᵢₜᵢᵥₑ/FN/GS_{base}.

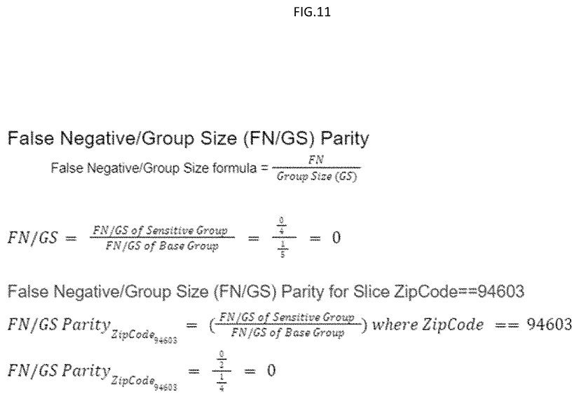

As with other optimization metrics, FN/GS can be calculated for one or more slices of the predictions (e.g., slice where zip code=94603). FN/GS _{‘zipcode=94603’}=number of FNs/group size, where zipcode=94603. The number of FNs in the sensitive group where zipcode is 94603 =FN_{‘Race=2’&& ‘zipcode=94603’}=0. The total number of outcomes in the sensitive group where zipcode=94603 is 2. FN/GS_{‘Race=2’&& ‘zipcode=94603’}=0/2=0. The number of FNs in the base group where zipcode is 94603=FN_{‘Race=3’&& ‘zipcode=94603’}=1. The total number of outcomes in the base group where zipcode=94603 is 4. FN/GS_{‘Race=3’&& ‘zipcode=94603’}=¼=0.25. Therefore, FN/GS Parity _{‘zipcode=94603’}=(0)/(0.25)=0. These calculations are illustrated in FIG. 11.

In an example embodiment, the optimization module 120 can be configured to determine an optimization metric called Accuracy, which can be a ratio of a sum of a number of TPs and TNs and a sum of a number of TPs, TNs, FPs, FNs. That is, Accuracy=(TP+TN)/(TP +TN +FP+FN). The optimization module 120 can be further configured to determine an optimization metric called Accuracy Parity, which can be a ratio of Accuracy of a sensitive group and Accuracy of a base group. That is, Accuracy Parity=Accuracyₛₑₙₛᵢₜᵢᵥₑ/Accuracy_{base}.

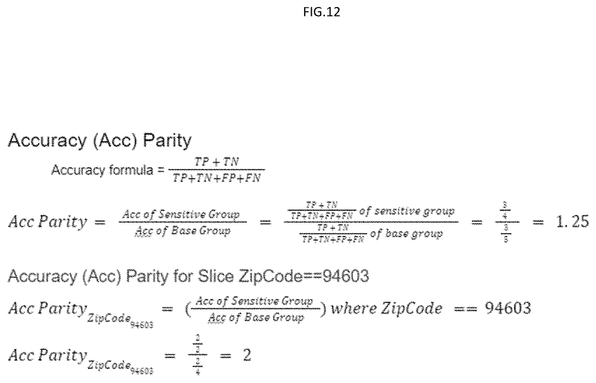

As with other optimization metrics, Accuracy can be calculated for one or more slices of the predictions (e.g., slice where zip code=94603). Accuracy _{‘zipcode=94603’}=(TP+TN)/(TP+TN+FP+FN), where zipcode=94603. Accuracy_{‘Race=2’&& ‘zipcode=94603’}=(number of TP′Race=2′&& ‘zipcode=94603’ +number of TN′Race=2′&& ‘zipcode=94603)/(number of TP_{1 Race=2’&& ‘zipcode=94603’}+number of TN_{‘Race=2’&& ‘zipcode=94603’}+number of FP_{‘Race=2’&& ‘zipcode=94603’}+number of FN_{‘Race=2’&& ‘zipcode=94603’})=(1+1)/(1+1+0+0)= 2/2=1. Accuracy_{‘Race=3’&& ‘zipcode=94603’}=(number of TP_{‘Race=3’&& ‘zipcode=94603’}+number of TN_{‘Race=3’1 && ‘zipcode=94603’})/(number of TP_{‘Race=3’&& ‘zipcode=94603’}+number of TN_{‘Race=3’&& ‘zipcode=94603’}+number of FP_{‘Race=3’&& ‘zipcode=94603’}+number of FN_{‘Race=3’&& ‘zipcode=94603’})=(2+0)/(2+0+1+1) =2/4 =0.5. Therefore, Accuracy Parity (for slice where zip code=94603)=Accuracy _{‘Race=2’&& ‘zipcode=94603’}/Accuracy _{‘Race=3’&& ‘zipcode=94603’}=(1)/(0.5)=2. These calculations are illustrated in FIG. 12.

In an example embodiment, the optimization module 120 can be configured to determine an optimization metric called Proportionality, which can be a ratio of a sum of a number of TPs and FPs and a sum of a number of TPs, TNs, FPs, FNs. That is, Proportionality=(TP+FP)/(TP+TN+FP+FN). The optimization module 120 can be further configured to determine an optimization metric called Proportional Parity, which can be a ratio of Proportionality of a sensitive group and Proportionality of a base group. That is, Proportional Parity=Proportionalₛₑₙₛᵢₜᵢᵥₑ/Proportional_{base}.

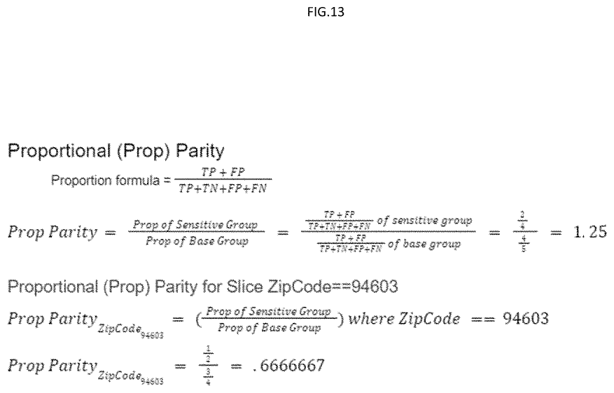

As with other optimization metrics, Proportionality can be calculated for one or more slices of the predictions (e.g., slice where zip code=94603). Proportionality _{‘zipcode=94603’}=(TP+FP)/(TP+TN+FP+FN), where zipcode=94603. Proportionality_{‘Race=2’&& ‘zipcode=94603’}=(number of TP_{‘Race=2’&& ‘zipcode=94603’}+number of FP_{‘Race=2’&& ‘zipcode=94603’})/(number of TP_{‘Race=2’&& ‘zipcode=94603’}+number of TN_{‘Race=2’&& ‘zipcode=94603’}+number of FP_{‘Race=2’&& ‘zipcode=94603’}+number of FN_{‘Race=2’&& ‘zipcode=94603’})=(1+0)/(1+1+0+0)=½=0.5. Proportionality _{‘Race=3’&& ‘zipcode=94603’}=(number of TP_{‘Race=3’&& ‘zipcode=94603’}+number of FP_{‘Race=3’&& ‘zipcode=94603’})/(number of TP_{‘Race=3’&& ‘zipcode=94603’}+number of TN_{‘Race=3’&& ‘zipcode=94603’}+number of FP_{‘Race=3’&& ‘zipcode=94603’}+number of FN_{‘Race=3’&& ‘zipcode=94603’})=(2+1)/(2+0+1+1)=¾=0.75. Therefore, Proportionality Parity (for slice where zip code=94603)=Proportionality _{‘Race=2’&& ‘zipcode=94603’}/Proportionality _{‘Race=3’&& ‘zipcode=94603’}=(0.5)/(0.75)=0.6667. These calculations are illustrated in FIG. 13.

In an example embodiment, the optimization module 120 can be configured to determine an optimization metric called False Omission Rate (FOR), which can be a ratio of a number of FNs and a sum of a number of TNs and FNs. That is, FOR=FN/(TN +FN). The optimization module 120 can be further configured to determine an optimization metric called FOR Parity, which can be a ratio of FOR of a sensitive group and FOR of a base group. That is,

FOR Parity =FORₛₑₙₛᵢₜᵢᵥₑ/FOR_{base}.

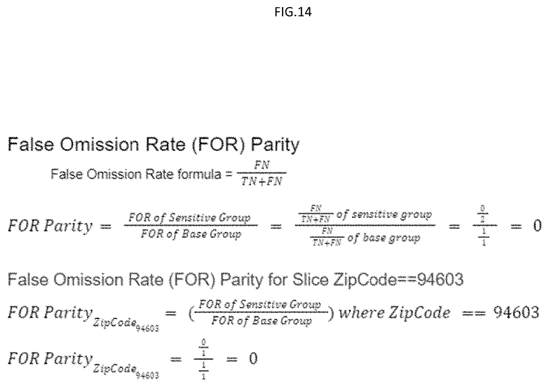

As with other optimization metrics, FOR can be calculated for one or more slices of the predictions (e.g., slice where zip code=94603). FOR _{‘zipcode=94603’}=FN/(TN+FN), where zipcode=94603. FOR _{‘Race=2’&& ‘zipcode=94603’}=(number of FN_{‘Race=2’&& ‘zipcode=94603’})/(number of TN_{‘Race=2’&& ‘zipcode=94603’}+number of FN_{‘Race=2’&& ‘zipcode=94603’})=(0)/(1+0)=0. FOR _{‘Race=3’&& ‘zipcode=94603’}=(number of FN_{‘Race=3’&& ‘zipcode=}94603’)/(number of TN_{‘Race=3’&& ‘zipcode=94603’}+number of FN_{‘Race=3’&& ‘zipcode=94603’})=(1)/(0+1)=1. Therefore, FOR Parity (for slice where zip code=94603)=FOR _{‘Race=2’&& ‘zipcode=94603}’/FOR _{‘Race=3’&& ‘zipcode=94603’=(}0)/(1)=0. These calculations are illustrated in FIG. 14.

In an example embodiment, the optimization module 120 can be configured to determine an optimization metric called False Discovery Rate (FDR) Parity, which can be a ratio of a number of FPs and a sum of a number of FPs and TPs. That is, FDR=FP/(FP+TP). The optimization module 120 can be further configured to determine an optimization metric called FDR Parity, which can be a ratio of FDR of a sensitive group and FDR of a base group. That is, FDR Parity=FDR ₛₑₙₛᵢₜᵢᵥₑ/FDR _{base}.

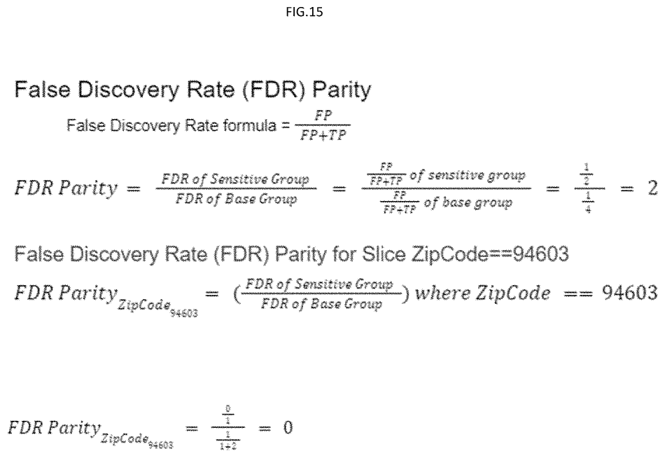

As with other optimization metrics, FDR can be calculated for one or more slices of the predictions (e.g., slice where zip code=94603). FDR_{‘zipcode=94603’}=FP/(FP+TP), where zipcode =94603. FDR _{‘Race=2’&& ‘zipcode=94603’}=(number of FP_{‘Race=2’&& ‘zipcode=94603’})/(number of FP_{‘Race=2’&& ‘zipcode=94603’}+number of TP_{‘Race=2’&& ‘zipcode=94603’})=(0)/(0+1)=0. FDR_{‘Race=3’&& ‘zipcode=94603’}=(number of FP_{‘Race=3’&& ‘zipcode=94603’})/(number of FP_{‘Race=3’&& ‘zipcode=94603’}+number of TP_{‘Race=3’&& ‘zipcode=94603’})=(1)/(1+2)=⅓=0.33. Therefore, FDR Parity (for slice where zip code=94603)=FDR _{‘Race=2’&& ‘zipcode=94603’}/FDR _{‘Race=3’&& ‘zipcode=94603’}=(0)/(0.33)=0. These calculations are illustrated in FIG. 15.

In an example embodiment, to link performance and volume of a slice into a single optimization metric, the performance by slice can be multiplied with the volume of the slice. Such a metric provides a fair comparison of slices irrespective of their size. This may allow for a creation of complex multidimensional slices and use the same metric for performance analysis. By fixing/adjusting the slice with the highest value (score) of a metric, the performance of machine learning model can improve the most. Because the volume is normalized, comparison of small volume slices to large volume slices can be made. This allows a creation of complex multidimensional slices and use the same metric for performance analysis.

U.S. Pat. No. 11,315,043 provides examples of linking performance and volume of a slice into an Accuracy Volume Score (AVS) metric. Similarly, for various bias metrics disclosed herein, performance and volume of a slice can be linked into a single volume score metric. Because it is normalized by volume, various dimensions can be properly compared.

In an example embodiment, the optimization module 120 being configured to sort and index the prediction slices based on their respective volume score metric. Similar to the example provided in U.S. Pat. No. 11,315,043 based on AVS, sorting and indexing can be done based on various bias metrics disclosed herein. Known techniques for sorting and indexing can be used. This can allow for fast searching and finding.

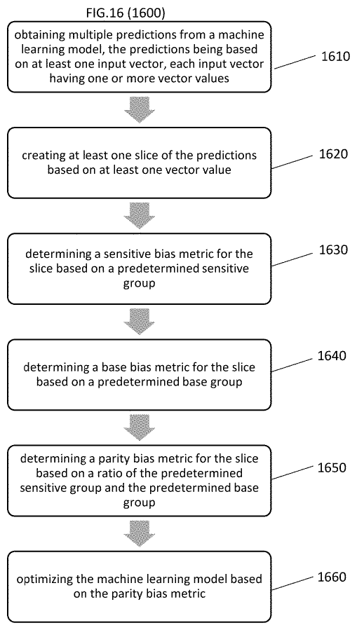

FIG. 16 shows a flowchart of a method 1600 for optimizing a machine learning model according to an embodiment of the present disclosure. The method 1600 can include a step 1610 of obtaining multiple predictions from a machine learning model such that the predictions are based on at least one input feature vector, each input feature vector having one or more vector values. Aspects of step 1610 relate to the previously described machine learning model 110 of the system 100.

The method 1000 can include a step 1620 of creating at least one slice of the predictions based on at least one vector value, a step 1630 of determining a sensitive bias metric for the slice based on a predetermined sensitive group, a step 1640 of determining a base bias metric for the slice based on a predetermined base group, a step 1650 of determining a parity bias metric for the slice based on a ratio of the predetermined sensitive group and the predetermined base group, and a step 1660 of optimizing the machine learning model based on the parity bias metric. Aspects of the steps 1620, 1630, 1640, 1650 and 1660 relate to the previously described optimization module 120 of the system 100.

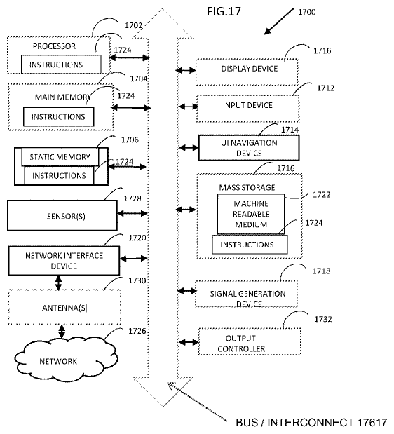

FIG. 17 is a block diagram illustrating an example computer system 1700 upon which any one or more of the methodologies (e.g., system 100 and/or method 1600) herein discussed may be run according to an example described herein. Computer system 1700 may be embodied as a computing device, providing operations of the components featured in the various figures, including components of the system 100, method 1600, or any other processing or computing platform or component described or referred to herein.

In alternative embodiments, the computer system 1700 can operate as a standalone device or may be connected (e.g., networked) to other machines. In a networked deployment, the computing system 1700 may operate in the capacity of either a server or a client machine in server-client network environments, or it may act as a peer machine in peer-to-peer (or distributed) network environments.

Example computer system 1700 includes a processor 1702 (e.g., a central processing unit (CPU), a graphics processing unit (GPU) or both), a main memory 1704 and a static memory 1706, which communicate with each other via an interconnect 1708 (e.g., a link, a bus, etc.). The computer system 1700 may further include a video display unit 1710, an input device 1712 (e.g., keyboard) and a user interface (UI) navigation device 1714 (e.g., a mouse). In one embodiment, the video display unit 1710, input device 1712 and UI navigation device 1714 are a touch screen display. The computer system 1700 may additionally include a storage device 1716 (e.g., a drive unit), a signal generation device 1718 (e.g., a speaker), an output controller 1732, and a network interface device 1720 (which may include or operably communicate with one or more antennas 1730, transceivers, or other wireless communications hardware), and one or more sensors 1728.

The storage device 1716 includes a machine-readable medium 1722 on which is stored one or more sets of data structures and instructions 1724 (e.g., software) embodying or utilized by any one or more of the methodologies or functions described herein. The instructions 1724 may also reside, completely or at least partially, within the main memory 1704, static memory 1706, and/or within the processor 1702 during execution thereof by the computer system 1700, with the main memory 1704, static memory 1706, and the processor 1702 constituting machine- readable media.

While the machine-readable medium 1722 (or computer-readable medium) is illustrated in an example embodiment to be a single medium, the term “machine-readable medium” may include a single medium or multiple medium (e.g., a centralized or distributed database, and/or associated caches and servers) that store the one or more instructions 1724.

The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions.

The term “machine-readable medium” shall accordingly be taken to include, but not be limited to, solid-state memories, optical media, magnetic media or other non-transitory media. Specific examples of machine-readable media include non-volatile memory, including, by way of example, semiconductor memory devices (e.g., Electrically Programmable Read-Only Memory (EPROM), Electrically Erasable Programmable Read-Only Memory (EEPROM)) and flash memory devices; magnetic disks such as internal hard disks and removable disks; magneto- optical disks; and CD-ROM and DVD-ROM disks.

The instructions 1724 may further be transmitted or received over a communications network 1726 using a transmission medium via the network interface device 1720 utilizing any one of several well-known transfer protocols (e.g., HTTP). Examples of communication networks include a local area network (LAN), wide area network (WAN), the Internet, mobile telephone networks, Plain Old Telephone (POTS) networks, and wireless data networks (e.g., Wi-Fi, 3G, and 4G LTE/LTE-A or WiMAX networks). The term “transmission medium” shall be taken to include any intangible medium that can store, encoding, or carrying instructions for execution by the machine, and includes digital or analog communications signals or other intangible medium to facilitate communication of such software.

Other applicable network configurations may be included within the scope of the presently described communication networks. Although examples were provided with reference to a local area wireless network configuration and a wide area Internet network connection, it will be understood that communications may also be facilitated using any number of personal area networks, LANs, and WANs, using any combination of wired or wireless transmission mediums.

The embodiments described above may be implemented in one or a combination of hardware, firmware, and software. For example, the features in the system architecture 1700 of the processing system may be client-operated software or be embodied on a server running an operating system with software running thereon. While some embodiments described herein illustrate only a single machine or device, the terms “system”, “machine”, or “device” shall also be taken to include any collection of machines or devices that individually or jointly execute a set (or multiple sets) of instructions to perform any one or more of the methodologies discussed herein.

Examples, as described herein, may include, or may operate on, logic or several components, modules, features, or mechanisms. Such items are tangible entities (e.g., hardware) capable of performing specified operations and may be configured or arranged in a certain manner. In an example, circuits may be arranged (e.g., internally or with respect to external entities such as other circuits) in a specified manner as a module, component, or feature. In an example, the whole or part of one or more computer systems (e.g., a standalone, client or server computer system) or one or more hardware processors may be configured by firmware or software (e.g., instructions, an application portion, or an application) as an item that operates to perform specified operations. In an example, the software may reside on a machine readable medium. In an example, the software, when executed by underlying hardware, causes the hardware to perform the specified operations.

Accordingly, such modules, components, and features are understood to encompass a tangible entity, be that an entity that is physically constructed, specifically configured (e.g., hardwired), or temporarily (e.g., transitorily) configured (e.g., programmed) to operate in a specified manner or to perform part or all operations described herein. Considering examples in which modules, components, and features are temporarily configured, each of the items need not be instantiated at any one moment in time. For example, where the modules, components, and features comprise a general-purpose hardware processor configured using software, the general- purpose hardware processor may be configured as respective different items at different times. Software may accordingly configure a hardware processor, for example, to constitute a particular item at one instance of time and to constitute a different item at a different instance of time.

Additional examples of the presently described method (e.g., 1600), system (e.g. 100), and device embodiments are suggested according to the structures and techniques described herein. Other non-limiting examples may be configured to operate separately or can be combined in any permutation or combination with any one or more of the other examples provided above or throughout the present disclosure.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

It should be noted that the terms “including” and “comprising” should be interpreted as meaning “including, but not limited to”. If not already set forth explicitly in the claims, the term “a” should be interpreted as “at least one” and “the”, “said”, etc. should be interpreted as “the at least one”, “said at least one”, etc. Furthermore, it is the Applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

The following references are incorporated by reference: “What does it mean for an algorithm to be fair?” at https://jeremykun.com/2015/07/13/what-does-it-mean-for-an-algorithm- to-be-fair/ (accessed Feb. 6, 2023); “Disparate Impact (DI)” at https://docs.aws.amazon.com/sagemaker/latest/dg/clarify-post-training-bias-metric-di.html (accessed Feb. 6, 2023); “Disparate Impact Analysis” at https://h2oai.github.io/tutorials/disparate-impact-analysis/#4 (accessed Feb. 6, 2023); “Quantifying bias in machine decisions” at https://cra.org/ccc/wp-content/uploads/sites/2/2019/05/Sharad-Goel_Machine-bias-CCC.pdf (accessed Feb. 6, 2023); “One definition of algorithmic fairness: statistical parity” at https://jeremykun.com/2015/10/19/one-definition-of-algorithmic-fairness-statistical-parity/(accessed Feb. 6, 2023).

1. A system for optimizing a machine learning model, the system comprising:
a machine learning model that generates predictions based on at least one input feature vector, each input feature vector having one or more vector values; and
an optimization module with a processor and an associated memory, the optimization module being configured to:
create at least one slice of the predictions based on at least one vector value,
determine a sensitive bias metric for the slice based on a sensitive group,
determine a base metric for the slice based on a base group,
determine a parity metric for the slice based on a ratio of the sensitive bias metric and the base metric, and
optimize the machine learning model based on the parity bias metric.

2. The system of claim 1, wherein the parity metric is Recall parity.

3. The system of claim 1, wherein the parity metric is False Positive Rate (FPR) parity.

4. The system of claim 1, wherein the parity metric is Disparate Impact (DI).

5. The system of claim 1, wherein the parity metric is False Negative Rate (FNR) parity.

6. The system of claim 1, wherein the parity metric is False Positive/Group Size (FP/GS) parity.

7. The system of claim 1, wherein the parity metric is False Negative/Group Size (FN/GS) parity.

8. The system of claim 1, wherein the parity metric is Accuracy parity.

9. The system of claim 1, wherein the parity metric is Proportional parity.

10. The system of claim 1, wherein the parity metric is False Omission Rate (FOR) parity.

11. The system of claim 1, wherein the parity metric is False Discovery Rate (FDR) parity.

12. A computer-implemented method for optimizing a machine learning model, the method comprising:
obtaining multiple predictions from a machine learning model, the predictions being based on at least one input feature vector, each input feature vector having one or more vector values;
creating at least one slice of the predictions based on at least one vector value;
determining a sensitive bias metric for the slice based on a sensitive group;
determining a base metric for the slice based on a base group;
determining a parity metric for the slice based on a ratio of the sensitive bias metric and the base metric; and
optimizing the machine learning model based on the parity metric.

13. The method of claim 12, wherein the parity metric is Recall parity.

14. The method of claim 12, wherein the parity metric is False Positive Rate (FPR) parity.

15. The method of claim 12, wherein the parity metric is Disparate Impact (DI).

16. The method of claim 12, wherein the parity metric is False Negative Rate (FNR) parity.

17. The method of claim 12, wherein the parity metric is False Positive/Group Size (FP/GS) parity.

18. The method of claim 12, wherein the parity metric is False Negative/Group Size (FN/GS) parity.

19. The method of claim 12, wherein the parity metric is Accuracy parity.

20. The method of claim 12, wherein the parity metric is Proportional parity.

21. The method of claim 12, wherein the parity metric is False Omission Rate (FOR) parity.

22. The method of claim 12, wherein the parity metric is False Discovery Rate (FDR) parity.
